(19) United States
(12) Patent Application Publication
(10) Pub. No.: US 2008/0268736 A1
(43) Pub. Date: Oct. 30, 2008

(54) Dope Dyed Flame Retardant Polyester Fibers, Textile Products Therefrom and the Method of Manufacturing Thereof

(75) Inventors: Seung Cheol Yang, Gyeonggi-Do (KR); Eung Soo Kim, Seoul (KR); Yang Kuk Son, Gunpo-Si (KR)

Correspondence Address: BIRCH STEWART KOLASCH & BIRCH, PO BOX 747, FALLS CHURCH, VA, 22040-0747, US

(73) Assignee: Hyosung Corporation, Seoul (KR)

(21) Appl. No.: 11/792,681

(22) PCT Filed: Apr. 8, 2005
(86) PCT No.: PCT/KR2005/000987

§ 371 Date: May 6, 2008

(30) Foreign Application Priority Data
Dec. 31, 2004 (KR) 10-2004-0118132

(51) Int. Cl. D03D 15/12; C08L 95/00

(52) U.S. Cl. 442/302; 524/59

(57) ABSTRACT

The present invention relates to dope dyed flame retardant polyester fibers, textile products therefrom, and the method of manufacturing thereof. The polyester fiber comprises flame retardant polyester polymers containing 500-50,000 ppm of phosphorus-based flame retardant agent based on phosphorus atom, and 500 5,000 ppm of carbon black based on said polyester polymers. The polyester fibers can provide excellent fastness and flame retardant characteristic without occurring hazardous, materials such as a dioxin during an incineration, and can be applied for fiber products such as blackout curtain having an effective light shielding.

### TECHNICAL FIELD

The present invention relates to a dope-dyed flame retardant polyester fiber, textile products made therefrom, and the method of manufacturing the same.

### BACKGROUND ART

Conventional methods of imparting flame retardancy to dope-dyed fibers may be broadly divided into a method involving flame retardancy by post-treatment and a method involving making fiber materials flame retardant, thereby imparting permanently flame retardant materials.

The conventional method using flame retardancy post-treatment to impart flame retardancy has been conventionally performed on natural fibers such as cotton and is also employed in the production of flame retardant synthetic fibers. However, the method of imparting flame retardancy via post-treatment presents problems associated with durability, and occurrence of environmental problems due to waste water generated during treatment. As such, this method is now widely used but would be phased out due to the increase of environmental interest.

In addition, as to the method involving rendering fiber materials permanently flame retardant, a method of imparting flame retardancy by copolymerization is primarily employed. For this purpose, reactive copolymerizable flame retardants are also variously commercialized.

Methods of forming flame retardant polyesters via copolymerization largely rely upon bromine (Br)-based flame retardants and phosphorus (P)-based flame retardants. As to patented inventions using bromine-based flame retardants, reference is made to Japanese Patent Publication Laid-open Nos. Sho 62-6912, 53-46398 and 51-28894. In this connection, bromine based compounds are susceptible to thermal degradation at high temperatures, and thus, a large quantity of flame retardants must be added in order to achieve effective flame retardancy. As a result, color and light fastness of the resulting polymeric material are deteriorated. In addition, due to the recent presentation of the possibility that bromine based flame retardants may give off carcinogenic substances such as dioxin and benzofuran, there is a movement towards regulation of brominated flame retardants, thereby actively facilitating substitution with the phosphorus based flame retardants.

As to patented inventions using phosphorus-based flame retardants, reference is made to U.S. Pat. Nos. 3,941,752, 5,899,428 and 5,180,793, and Japanese Patent Publication Laid-open No. Sho 50-56488. Reactive flame retardants disclosed in these patents have disadvantages such as deterioration of physical properties due to hydrolysis upon post-treatment, in particular dyeing polyester fibers, because phosphorus atoms are bound to a main chain or backbone of the polymer. Because the P—O linkage has a somewhat lower bond energy than any other linkage in copolyester polymer.

In addition, flame retardant polyester fibers prepared using the above-mentioned patent methods lack UV stability and thus suffer from deterioration of flame retardancy durability and physical properties of the fibers upon prolonged exposure to sunlight.

Meanwhile, intrinsic properties of polyester fibers make it difficult to impart them with deep colors by dyeing. In addition, polyester fibers exhibit low fastness because fibers and dyes are not bound by chemical bonding. That is, as can be seen from their polymer structures, polyester fibers do not have reactive groups capable of undergoing chemical reaction, such as hydroxyl groups or amide groups.

Therefore, polyester fibers have a disadvantage that they are dyed only by disperse dyes. Since adsorbed dyes are not chemically bound to the fibers, the dyes may be separated from the fibers upon exposure to high temperatures or organic solvents such as N,N-dimethyl formamide.

In order to solve such problems, a large number of methods have been proposed to blend pigments or dyes into fibers during fiber formation. However, production of fibers having various colors is not suitable for industrial and large-scale production and thereby, among various colors, only dark black colored yarns have been produced in industrial and large-scale. Further, since it is difficult to effect deep black color dyeing with general dyeing methods, dope-dyed filaments have been produced to exhibit deep black color and to solve fastness problems. Reference may be made to the following methods of producing dope-dyed filaments.

Firstly, there is a method involving introducing dyes or pigments during a polymerization process. This method serves to make special polymers by introducing dyes or pigments during polymerization. Dyes or pigments are generally provided as fine powders. Accordingly, ethylene glycol (hereinafter, referred to as “EG”) is used to dissolve or disperse the dyes or pigments for introduction. In addition, liquid dyes or pigments are introduced alone or diluted in EG prior to introduction. This method is advantageous for preparing uniformly dispersed polymer products, but suffers from contamination of polymerization apparatuses with dyes or pigments. In particular, when a batch process is employed to prepare polymer products, color difference between batches may occur and contamination of polymerization apparatuses makes it difficult to produce different kinds of polymer products in the same apparatus.

Secondly, there is a method involving blending and spinning master batches. This method involves blending a master batch, containing a high concentration of pigments or dyes, with conventional polyester polymers, followed by spinning, and is simple. In particular, black color products can be prepared by blending a master batch containing a large amount of carbon black with conventional polyester polymers. In this method, since spinning workability and properties of the resulting fibers vary depending upon kinds of base resins in the master batch (polymers used in the mater batch), selection of the master batch and optimal content is important.

Thirdly, there is a method involving fiber dyeing and post-processing. This method is performed by adsorbing an excess amount of black pigments or dyes on a surface of the prepared polyester fibers at a high temperature, followed by drying, or fixing them on the fiber surface by crosslinking, in order to enhance fastness. This method is not widely employed due to its very high production costs, low productivity, and difficulty in the uniformity of the products.

Meanwhile, Japanese Patent Publication Laid-open Nos. Hei 3-137227, 3-137228, 10-77523 and 3-131051 propose methods of producing dope-dyed fibers using pigments such as carbon black in fibers. These methods primarily relate to production of nylon for fishing nets or high tenacity yarns such as seat belts, and thus are not suited for dope-dyed flame retardant polyester fibers as are the aim of the present invention.

As described above, there have been known methods of imparting flame retardancy to polyester fibers or methods of increasing fastness by preparing dope-dyed filaments, respectively, but a method of simultaneously imparting two functionalities, while having UV stability and light shieldability, is not yet known in the art.

### DISCLOSURE

### Technical Problem

Therefore, the present invention has been made in view of the above problems, and it is an object of the present invention to provide a dope-dyed flame retardant polyester fiber having permanent flame retardancy, superior flame retardancy durability and UV stability, and high fastness by introduction of pigments into fiber itself, a method of preparing thereof, and fiber products having excellent flame retardancy and light shieldability, such as blackout curtains, using the same.

### Technical Solution

In accordance with the present invention, the above and other objects can be accomplished by the provision of a dope-dyed flame retardant polyester fiber, comprising 500 to 5000 ppm of carbon black in a flame retardant polyester polymer containing 500 to 50000 ppm of a phosphorus based flame retardant based on phosphorus atoms.

Other objects, particular advantages and novel characteristics of the present invention will be more clear from the following detailed description and preferred embodiments.

### BEST MODE

Construction of dope-dyed flame retardant polyester fibers in accordance with the present invention will now be described.

The present inventors have conducted tests on a variety of flame retardants in order to impart permanent flame retardancy to polyester fibers. Currently, flame retardants, which are industrially used to impart flame retardancy, are broadly classified into halogen based flame retardants and phosphorus based flame retardants. The halogen based flame retardants are known to exhibit superior flame retardancy to the phosphorus based flame retardants, but the halogen based flame retardants, represented primarily by bromine, give off carcinogenic substances such as dioxin upon burning and thus regulations on use thereof are gradually being instituted.

In addition, the phosphorus based flame retardants are broadly divided into main-chain type flame retardants in which flame retardancy-imparting phosphorus atoms are directly attached to polyester backbones and side-chain type flame retardants in which phosphorus atoms are attached to polyester backbones via side chains.

The present inventors have discovered a flame retardant represented by the following general formula 1, as a side-chain type flame retardant that exhibits excellent resistance to hydrolysis.

The side-chain type flame retardant represented by the following general formula 1 has reactive groups capable of undergoing esterification or transesterification in its own molecular structure and thus is co-polymerizable with polyethylene terephthalate.

As base polyester polymer resins that can be used in the present invention, mention may be made of polyethylene terephthalate, polybutylene terephthalate, copolymerized polyethylene terephthalate containing 12 mol % or less of isophthalic acid, or a copolymerized polybutylene terephthalate resin containing 12 mol % or less of isophthalic acid.

The content of the flame retardant of general formula 1 in the polymer is in the range of 500 to 50,000 ppm, and more preferably 1,000 to 20,000 ppm, based on phosphorus atoms. Where the phosphorus atom content is less than 500 ppm, desired flame retarding effects cannot be obtained. In contrast, the phosphorus atom content greater than 50,000 ppm undesirably results in difficulty to increase the degree of polymerization of the resulting polyester and remarkably reduces crystallinity, thereby making it difficult to produce fibers or films.

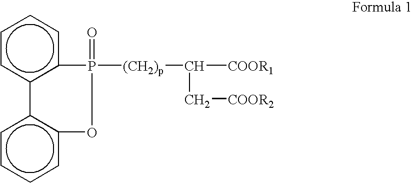

wherein R₁ and R₂ are independently hydrogen or a different or same radical having a ω-hydroxyl group and containing 2 to 4 carbon atoms, and p is an integer between 1 and 5.

Further, the present invention is intended for light shielding, and thus stability of the polymer upon exposure to sunlight, in particular UV light, is of primary importance. As such, UV stability is certainly necessary and thereby it is important to add a UV stabilizer.

As a result of various tests, the present inventors have found that manganese phosphate is most effective. However, manganese phosphate is insoluble in ethylene glycol, thereby making it difficult to be incorporated into the polymer. Therefore, the present inventors have found that it is most proper to synthesize manganese phosphate in a reaction system by separately introducing manganese acetate and phosphoric acid to the reactor, instead of directly introducing manganese phosphate into a reactor.

The content of manganese acetate utilized for synthesis of manganese phosphate is preferably in the range of 0.1 to 500 ppm, and more preferably 0.2 to 200 ppm, based on manganese atoms in the polymer. If the content of manganese acetate is below 0.1 ppm, it is difficult to obtain the desired UV stability. If the content of manganese acetate exceeds 500 ppm, problems associated with dispersibility arise, thereby leading to increased pack pressure upon spinning.

In addition, the content of phosphoric acid is preferably in the range of 0.1 to 500 ppm, and more preferably 0.2 to 200 ppm based on the phosphorus atom content relative to the polymer. Although phosphorus based materials may be added in any amount, so long as the reaction between the phosphorus material and the manganese salt is not inhibited, concentrations greater than 500 ppm may lead to decreased catalytic activity, thereby it making difficult to prepare the desired flame retardant polyester.

In the present invention, tests were focused on enhancement of fastness of black color in the flame retardant polyester fibers.

Direct introduction of pigments or dyes into a polymerization process undesirably presented problems such as contamination of polymerization apparatuses and color difference between batches. In addition, in a fiber dyeing method, it was difficult to select pigments or dyes showing affinity for polyester fibers. When resins were added to fibers, followed by curing, in order to increase fixing capacity of pigments or dyes, the resulting fibers exhibited high rigidity, and reduced flame retardancy.

As such, the present invention has selected a method using a master batch. In the present invention, it was found that selection of a base resin constituting the master batch is important. The base resin of the master batch, even when it was blended in a small amount with flame retardant polyester polymers, caused color differences if the base resin was incompatible with the flame retardant polymer. In addition, where the difference in heat resistance between the base resin and polyester polymers is large, it was found that qualities of the resulting products were deteriorated in a manufacturing process and post-processing of fibers. The base resin of the master batch should be compatible with the flame retardant polyester polymer utilized in the present invention and satisfy the following inequality 1 in order to obtain excellent processability in a spinning process and the like:

T_{FR}−20° C.≦T_{B}≦T_{FR}+20° C. 1

wherein T_{FR} is a melting point of the flame retardant polyester polymer and T_{B} is a melting point of the base resin of the master batch.

220° C.≦Tₘ≦250° C. 2

wherein Tₘ is a melting point of the prepared fiber, excluding the case in which the number of melting point peaks is two or more.

Analysis of melting points was performed using a DSC 7 differential scanning calorimeter (Perkin Elmer).

If T_{B} is lower than T_{FR}−20° C., the melting point difference between the base resin and the flame retardant polyester polymer is too high, thereby making it difficult to achieve uniform spinning. In contrast, if T_{B} is higher than T_{FR}+20° C., incomplete melting occurs upon spinning and this then causes heterogeneous discharging resulting in frequent blow out leading to deterioration of workability, or unreacted base resin serves as a contaminant, thereby deteriorating fiber quality.

In addition, if the melting point of the prepared fiber, Tₘ is lower than 220° C., heat resistance is lowered and thus fusion of fibers and tight spots tend to occur in post-processing. Whereas, if Tₘ is higher than 250° C., another melting peak is developed due to phase separation, thereby it is difficult to obtain fibers having uniform physical properties and it is difficult to prepare products having uniform colors.

Existence of two or more melting points exhibited in the prepared fibers represents a state in which two or more polymers are simply mixed without compatibility therebetween, thus resulting in ununiform distribution in the polymer melt leading to difficulty in application as fibers.

Further, pigments or dyes utilized in the present invention are employed in high-temperature polyester polymerization and spinning processes and thus they should have superior heat resistance. Therefore, upon comparing and evaluating various materials on the basis of industrially reasonable costs and performance, inorganic pigments were found adequate in the present invention. In particular, carbon black was preferred. Conventional disperse dyes for polyester fibers were decomposed at a high temperature of about 280 to 300° C., thereby making it difficult to use them due to color changes.

In addition, suitable content of carbon black is between 500 and 5000 ppm, relative to the flame retardant polyester fibers. If the content of carbon black is less than 500 ppm, it is difficult to develop desired colors and it is also difficult to effect uniform blending, thereby resulting in occurrence of inferior dyeing. Whereas, if the content of carbon black is higher than 5000 ppm, the amount of carbon black added is too much, thus leading to increased production costs and deterioration of spinnability.

Although the spinning process in accordance with the present invention is a spin-draw process whereby drawing is performed in conjunction with spinning, it is also possible to perform drawing or false twisting after preparing partially oriented yarns (POY).

### MODE FOR INVENTION

### Examples

Now, the present invention will be described in more detail with reference to the following Examples and Comparative Examples. These examples are provided only for illustrating the present invention and should not be construed as limiting the scope and spirit of the present invention.

### Examples 1 through 5 and Comparative Examples 1 through 3

A slurry of 8650 g of terephthalic acid (hereinafter, referred to as “TPA”) and 2700 g of ethylene glycol (hereinafter, referred to as “EG”) was subjected to esterification using a semi-batch process.

Oligomers prepared to have the same composition as in the slurry were stirred in an esterification reactor while the temperature of the reactor was maintained at 250 to 260° C. After completion of slurry introduction, esterification was additionally progressed for 30 minutes, thereby reaching an esterification reaction rate of 96.5%. The prepared oligomers were transferred to a polycondensation reactor. As the flame retardant, a EG solution in which the concentration of a compound of a general formula 1 (wherein p is 1, R₁ and R₂ are CH₂CH₂OH) was 65 weight % was used. 1380 g of the flame retardant solution was introduced to the reactor, and then manganese acetate and phosphoric acid, as UV stabilizers, were added to the reactor with the concentrations of 44 ppm and 75 ppm, respectively, based on manganese and phosphorus atoms. Next, as a catalyst, 200 g of a solution in which 2% by weight of antimony trioxide had been dissolved in EG was added and vacuum was applied. A conventional polyester polymerization method was used to perform polycondensation, thereby obtaining polymers having an intrinsic viscosity (IV) of 0.65 dl/g.

Physical properties of the thus-prepared flame retardant polyester polymers are as follows:

Melting point: 242.8° C., Intrinsic viscosity: 0.64 dl/g, DEG: 1.30 wt %, phosphorus content: 6000 ppm, Color: L 63, a −2.2 and b 1.0.

A master batch was prepared to contain 30% by weight of carbon black using respective polymers listed in Table 1 and a twin extruder.

The prepared flame retardant polyester polymers and the master batches having the same composition as shown in Table 1 were subjected to spinning and yarn processing so as to prepare dope-dyed flame retardant polyester fibers.

### Comparative Example 4

This example was carried out using the same procedure as in Example 1, except that flame retardant polyester polymers were prepared to have phosphorus content of 280 ppm.

TABLE 1

| | | Ex. | Ex. | Ex. | Ex. | Ex. | Comp. | Comp. | Comp. | Comp. |
|---|---|---|---|---|---|---|---|---|---|---|
| Items | | 1 | 2 | 3 | 4 | 5 | Ex. 1 | Ex. 2 | Ex. 3 | Ex. 4 |
| Base resin*¹ | | PET | CoPET | PET | PBT | PET | PP | Ny | PEN | PET |
| T_{B} (° C.) | | 253 | 251 | 254 | 227 | 254 | 166 | 230 | 268 | 253 |
| Master batch content | | 4 | 4 | 4 | 4 | 3 | 4 | 4 | 1 | 4 |
| (ppm)*² | | | | | | | | | | |
| Carbon black content | | 1200 | 1200 | 1200 | 1200 | 900 | 1200 | 1200 | 300 | 1200 |
| (ppm) | | | | | | | | | | |
| Phosphorus (P) | | 6000 | 6000 | 6000 | 6000 | 6000 | 6000 | 6000 | 6000 | 280 |
| content (ppm) | | | | | | | | | | |
| Spinning | GR1 speed | 3140 | 3140 | 3140 | 1350 | 1350 | 1350 | 1350 | 3140 | 3140 |
| | (m/min) | | | | | | | | | |
| | GR1 Temp. | — | — | — | 80 | 80 | 80 | 80 | | — |
| | (° C.) | | | | | | | | | |
| | GR2 speed | 3150 | 3150 | 3150 | 4100 | 4100 | 4100 | 4100 | 3150 | 3150 |
| | (m/min) | | | | | | | | | |
| | GR2 Temp. | — | — | — | 120 | 120 | 120 | 120 | | — |
| | (° C.) | | | | | | | | | |
| Yarn | Strength | 2.15 | 2.14 | 2.15 | 3.95 | 4.01 | 4.05 | 4.11 | 2.17 | 2.16 |
| properties | (g/d) | | | | | | | | | |
| | Elongation | 160 | 158 | 160 | 38 | 37 | 36 | 35 | 163 | 159 |
| | (%) | | | | | | | | | |
| | Dyeability*³ | — | — | — | ⊚ | ⊚ | X | Salt | X | — |
| | | | | | | | | stains | | |
| | | | | | | | | occurred | | |
| | Tm(° C.)*⁴ | 242 | 240 | 242 | 239 | 241 | Two | Two | 241 | 241 |
| | | | | | | | peaks | peaks | | |
| Spinnability*⁵ | | | ⊚ | ⊚ | ⊚ | ⊚ | X | X | ⊚ | |
| Drawing | draw ratio | — | — | 1.6 | — | — | — | | — | — |
| | Hot roller | — | — | 90 | — | — | — | | — | — |
| | temp.(° C.) | | | | | | | | | |
| | Hot plate | — | — | 135 | — | — | — | | — | — |
| | temp.(° C.) | | | | | | | | | |
| Physical | Strength | — | — | 4.3 | — | — | — | | — | — |
| properties | (g/d) | | | | | | | | | |
| of drawn | Elongation | — | — | 34 | — | — | — | | — | — |
| yarns | (%) | | | | | | | | | |
| | Dyeability | — | — | ⊚ | — | — | — | | — | — |
| False | DR | 1.86 | 1.86 | | — | — | — | | 1.86 | 1.86 |
| twisting | VR | 1.50 | 1.50 | | — | — | — | | 1.50 | 1.50 |
| | Temp.(° C.) | 160 | 160 | | — | — | — | | 160 | 160 |
| Physical | Strength | 4.0 | 4.1 | | — | — | — | | 4.4 | 3.9 |
| properties | (g/d) | | | | | | | | | |
| of false | Elongation | 29 | 27 | | — | — | — | | 27 | 29 |
| twist | (%) | | | | | | | | | |
| yarns | Dyeability | ⊚ | ⊚ | | — | — | — | | X | ⊚ |
| | Flame | 31 | 30 | 30 | 31 | 31 | — | — | 30 | 22 |
| | retardancy | | | | | | | | | |
| | (LOI) | | | | | | | | | |

*¹Base resin
PET: Polyethylene terephthalate
PBT: Polybutylene terephthalate
CoPET: PET copolymerized with 2.5 mol % of isophthalic acid
PEN: Polyethylene naphthalate
*²Master batch content: wt % of master batch upon blending (weight of master batch/(weight of master batch + weight of flame retardant polyester polymer) × 100)
*³Dyeability: ⊚: no difference in dyeing, X: difference in dyeing in one or more samples, as evaluated with the naked eye, using 10 circular knitted fabrics prepared by hose knitting the prepared fibers. Separately marking for salt stain formed
*⁴Two peaks in the Tₘ column represents occurrence of two peaks on a DSC chart
*⁵Spinnability: ⊚ representing less than 3 times yarn breakages in a day spinning process; X representing 3 or more yarn breakages
*⁶Flame retardancy: The prepared fibers were tested according to KS M 3032, thereby evaluating LOI(Limited Oxygen Index).

### Example 6

False twist yarns of dope-dyed flame retardant polyesters prepared in Example 1 and commercially available flame retardant polyester false twist yarn, SDM 150/144 (Hyosung, Korea), as weft and warp, respectively, were used to weave double faced satins which were then evaluated on performance as a blackout curtain.

Flame retardancy of the blackout curtain was evaluated according to US standard, NFPA 701, and the blackout curtain passed the examination. In addition, shading rate of the blackout curtain was evaluated according to Japanese Standard, JIS L 1055, and was found to be 99.8%.

As described above, dope-dyed flame retardant polyester fibers in accordance with the present invention have excellent flame retardancy, UV stability and fastness. In particular, use of fibers in accordance with the present invention in preparing blackout curtains or the like can simultaneously provide excellent flame retardancy and light shieldability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A dope-dyed flame retardant polyester fiber, comprising 500 to 5000 ppm of carbon black in a flame retardant polyester polymer containing 500 to 50000 ppm of a phosphorus based flame retardant based on phosphorus atoms.

2. The polyester fiber according to claim 1, wherein the dope-dyed flame retardant polyester fiber satisfies the following inequality 2:
220° C.≦Tₘ≦250° C. 2
wherein Tₘ is a melting point of the prepared fiber.

3. The polyester fiber according to claim 1, wherein the phosphorus based flame retardant is represented by the following general formula 1: 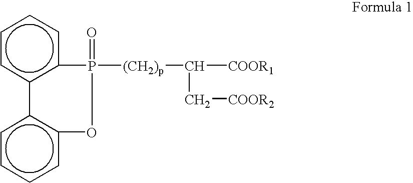
wherein R₁ and R₂ are independently hydrogen or a different or same radical having a ω-hydroxyl group and containing 2 to 4 carbon atoms, and p is an integer between 1 and 5.

4. The polyester fiber according to claim 1, wherein the base resin of the master batch introducing carbon black into the fiber is a polyester polymer satisfying the following inequality 1:
T_{FR}−20° C.≦T_{B}≦T_{FR}+20° C. 1
wherein T_{FR} is a melting point of the flame retardant polyester polymer and T_{B} is a melting point of the base resin of the master batch.

5. The polyester fiber according to claim 4, wherein the polyester polymer is selected from polyethylene terephthalate, polybutylene terephthalate, copolymerized polyethylene terephthalate containing 12 mol % or less of isophthalic acid and copolymerized polybutylene terephthalate containing 12 mol % or less of isophthalic acid.

6. A method for preparing dope-dyed flame retardant polyester fiber, comprising adding 500 to 5000 ppm of carbon black to a flame retardant polyester polymer containing 500 to 50000 ppm of a phosphorus based flame retardant based on phosphorus atoms, using a carbon black master batch.

7. A dope-dyed flame retardant polyester woven or knitted fabric comprising the dope-dyed flame retardant polyester fiber according to any one of claims 1 through 5.

8. A flame retardant blackout curtain comprising the dope-dyed flame retardant polyester fiber according to any one of claims 1 through 5.
